(19) United States
(12) Patent Application Publication
(10) Pub. No.: US 2003/0209860 A1
(43) Pub. Date: Nov. 13, 2003

(54) Sealing ring

(75) Inventors: Eric Kammerer, Langres (FR); Matthias Wehke, Langres (FR); Celine Guillerme, Neuilly L'eveque (FR)

Correspondence Address: DAVIDSON, DAVIDSON & KAPPEL, LLC, 485 SEVENTH AVENUE, 14TH FLOOR, NEW YORK, NY, 10018, US

(73) Assignee: Carl Freudenberg KG, Weinheim (DE)

(21) Appl. No.: 10/407,020

(22) Filed: Apr. 4, 2003

(30) Foreign Application Priority Data
Apr. 5, 2002 (DE) DE 102 151 87.3

(51) Int. Cl. F16J 15/34

(52) U.S. Cl. 277/400

(57) ABSTRACT

A sealing ring for sealing a shaft relative to an interior space. The sealing ring includes a supporting ring and a sealing disc attached to the supporting ring. The sealing disc includes a projection conically deformed in an axial direction of the shaft and has a first section in contact with the shaft. The first section includes a helical groove configured to allow return of a medium toward the interior space and a web separating adjacent turns of the helical groove. The groove has a trapezoidal cross section and/or a cross section larger than a cross section of the web.

Priority is claimed to German Patent Application No. DE 102 15 187.3, filed on Apr. 5, 2002, which is incorporated by reference herein.

### BACKGROUND

The present invention relates to a sealing ring, and in particular a sealing ring for sealing a shaft.

A sealing ring is generally known, for example from German Patent Application 100 33 446 A1. The known sealing ring includes a supporting ring and a sealing disc attached to it, made of an elastomer material, which form-fittingly encloses a shaft to be scaled having a projection, which is conically deformed in the axial direction. The sealing disc has a helical groove in the section of the projection which is in contact with the shaft, for the return flow of the medium to be sealed in the direction of the space to be sealed. The flank surfaces delimiting the groove are situated parallel to one another. The bottom surface, which is formed by the groove base, connects—in the sectional view—the flank surfaces in an essentially semicircular shape, the groove having a cross section, which is significantly smaller than the cross section of each web separating the successive turns from one another.

In such a design it is a disadvantage that the small flow cross section of the groove limits the return flow capability, in particular at high rotational speeds of the shaft to be sealed. Carbonized oil and floating particles from the medium to be sealed can accumulate inside the groove and thus further minimize the flow cross section, which is small anyhow.

### SUMMARY OF THE INVENTION

An advantage of a trapezoidal groove versus a U-shaped groove is that it prevents parts of the flow of the medium to be sealed from chopping in the swirl groove. Due to the fact that the flow does not chop within the swirl groove, no floating particles accumulate within the swirl groove; they do not heat up, do not carbonize, and thus do not clog the swirl groove.

An object of the present invention is to prevent the above-mentioned disadvantages. In particular, the return flow capability of the groove at high rotational speeds and during a long operating period is to be increased and carbon deposits are to be prevented. The sealing ring according to the present invention is to have improved usage properties during a longer operating period.

The present invention provides a sealing ring that includes a supporting ring (1) and a sealing disc (2) attached to it, which is in contact with a shaft (3) to be sealed via a projection (4) conically deformed in the axial direction. The projection (4) has at least one helical groove (6) for the return flow of a medium to be sealed toward the space (7) to be sealed in at least the section (5) in contact with the shaft (3). The groove (6) has a trapezoidal profile.

The present invention also provides a sealing ring, that includes a supporting ring (1) and a sealing disc (2) attached to it, which is in contact with a shaft (3) to be sealed via a projection (4) conically deformed in the axial direction. The projection (4) has at least one helical groove (6) for the return flow of a medium to be sealed toward the space (7) to be sealed in at least the section (5) in contact with the shaft (3). The groove (6) has a cross section which is larger than the cross section of each web (17, 17.1, 17.2 . . . ) separating the successive turns (16, 16.1, 16.2, . . . ) from one another.

Thus, a sealing ring including a supporting ring and, attached to it, a sealing disc is provided; the sealing disc is in contact with a shaft to be sealed, having a projection which is conically deformed in the axial direction, the projection has at least one helical groove in at least the section in contact with the shaft for the return flow of the medium to be sealed in the direction of the space to be sealed, the groove having a trapezoidal profile and/or a cross section which is larger than the cross section of each web which separates the successive turns from one another. The trapezoidal profile of the groove has the advantage over the profile of the sealing ring initially mentioned in the related art.

Due to the trapezoidal profile of the groove, the return flow capability of the medium to be sealed is increased by approximately one-third versus swirl grooves having a U-shaped profile. This increased return flow capability is sustained even after extremely long operating periods since the swirl groove has no hydraulic dead spaces and no sharp corners and edges. Such a swirl groove is less susceptible to carbon deposits.

In general, the sealing disc may be made of a polymer or an elastomer material. The sealing disc may be made of an elastomer or of a PTFE (polytetrafluorethylene) compound for example. Alternative materials for the sealing disc are thermoplastics, cross-linkable thermoplastics, or thermosetting plastics. As a function of the respective circumstances of the application, the sealing disc may be conically concave in the direction of the space to be sealed or against the space to be sealed, i.e., in the direction of the environment. Independently of such a design, the medium to be sealed flows back toward the space to be sealed because of the appropriate design of the helical groove.

According to an advantageous design, the sealing disc may have a cylindrical contact surface toward the shaft, the contact surface being delimited on both sides in the axial direction by flank surfaces of the groove which are conically inclined towards one another, the flank surfaces merging into a cylindrical bottom surface which forms the groove base. Both the contact surface and the bottom surface extend parallel to one another in a spiral shape corresponding to the groove. The essentially planar bottom surface has the advantage over bottom surfaces having semicircularly rounded groove bases in that a large groove width is achieved without the groove having an unnecessary depth. A very deep groove would complicate the manufacture and would undesirably weaken the sealing disc.

The flank surfaces may be separated from the contact surface and the bottom surface by roundings. Preventing sudden direction changes within the groove has the advantage that the danger of carbonized oil deposits is reduced to a minimum.

With regard to a simple and cost-effective manufacturability, all roundings may have an essentially identical radius.

The radii of the roundings may measure between 0.05 mm and 0.2 mm. Such a range has the advantage that on the one hand the radii are large enough to prevent hydraulic dead spaces and carbonized oil deposits in the groove, as well as to prevent notch effects in the transition area between the flank surfaces and the groove base. On the other hand, the cross section of the groove is not overly limited, which would be undesirable. If the radii were smaller than 0.05 mm, then the danger of carbonized oil deposits und undesirable notch effects would increase; were the radii, however, larger than 0.2 mm the flow cross section of the groove would be undesirably reduced.

The groove may have several turns. The return flow effect of the medium to be sealed in the direction of the space to be sealed is thereby improved. It is also an advantage that several turns of the sealing section of the sealing disc rest on the shaft, decreasing the specific contact pressure without reducing the return flow.

The groove has a cross section that is larger than the cross section of each web separating the successive turns. Such a ratio is required in order to achieve an increased return flow capability of the groove, even at high rotational speeds. If, for example, the ratio of the cross section of the groove to the cross section of a web is at least 1.5, then, during the intended use of the sealing ring, a return flow capability of the medium to be sealed in the direction of the space to be sealed is obtained which, at a rotational speed of the shaft to be sealed of approximately 6000 min⁻¹, is 30% greater than in comparable sealing rings in which the above-mentioned ratio is 1 or less. Due to the ratio greater than 1, the increased return flow capability of the medium to be sealed in the direction of the space to be sealed is sustained even after an extremely long operating period of the sealing ring, since even usual amounts of carbonized oil deposits, during a very long operating period, have only a negligible small influence on the size of the flow cross section of the groove, and thus on the usage properties of the sealing ring.

The groove may have an isosceles profile. It is an advantage here that the shaping tool for the isosceles trapezoid is cost-effectively manufacturable, since fewer machining tools and fewer process steps are needed.

According to another design, there is the possibility that the groove has a scalene profile. It is an advantage, compared to grooves having an isosceles profile, that, with an increased amount of lubricant at the sealing point, the scalene trapezoid has a greater return flow effect.

The groove may form a component of a single-flight thread or of a multi-flight thread. The single-flight thread, easier to manufacture, has the additional advantage that less ambient air is pumped into the unit. The single-flight swirl groove is preferably used in engine seals. Operating conditions include mostly splash oil and a slightly pulsating partial vacuum in the engine.

In contrast, a groove forming a component of a multi-flight thread is preferably used when an oil level at the sealing point and a slight overpressure in the unit are to be sealed.

Preferably, the groove has a depth that represents 15% to 75% of the thickness of the sealing disc. Further improved usage properties of the sealing ring occur when the depth has 35% to 45% of the thickness of the sealing disc. If the groove has a depth which is less than 15% of the thickness of the sealing disc, the return flow capability is heavily limited by the comparably small flow cross section, which is undesirable. However, if the groove has a depth that is greater than 75% of the thickness of the sealing disc, then the remaining thickness of the sealing disc in the area of the groove is only very small. The radial contact pressure of the sealing disc in the section in contact with the shaft is thereby only relatively low, so that, during the intended use of the sealing ring, leakages may occur in this area.

The groove may have a depth of between 0.2 mm and 0.4 mm, preferably between 0.25 mm and 0.28 mm. Such depths are particularly advantageous for most applications and dimensions of the sealing ring according to the present invention.

The successive turns of the groove may have a pitch of between 0.4 mm and 0.8 mm. The pitch of the successive turns preferably measures between 0.5 mm and 0.7 mm. Groove pitches of between 0.4 mm and 0.8 mm, preferably between 0.5 mm and 0.7 mm, have the advantage that a sufficient number of turns are in contact with the shaft.

It is a disadvantage if the groove pitch measures less than 0.4 mm, because the pitch is too small for a sufficient return flow.

On the other hand, it is a disadvantage if the pitch measures more than 0.8 mm, because only a small number of turns is possible, particularly in sections in the axial direction in which the conically deformed projection form-fittingly contacts the shaft to be sealed, whereby the return flow effect of the medium to be sealed in the direction of the space to be sealed is undesirably limited.

The sealing disc may have an essentially flat surface on the side facing away from the groove. In this respect, the sealing ring is manufacturable in a particularly simple and cost-efficient manner.

There is the possibility, however, that the sealing disc has an essentially wave-shaped surface on the side facing away from the groove, thereby creating an enlarged surface; the heat transfer from the large, essentially wave-shaped surface to the surroundings is thus improved so that, during an extended operating period, improved usage properties of the sealing ring are obtained. The carbonized oil formation is thereby reduced.

The sealing disc may be made of PTFE. Sealing discs made of such a material are resistant against most media to be sealed and have exceptionally good usage properties during very long operating periods. After a certain negligibly small initial wear, the surface of the sealing disc glazes in the area of the section in contact with the shaft to be sealed, which makes it particularly resistant. In addition, PTFE tends to resume its original form after deformations. In the area of the conically deformed projection, a sufficient contact pressure of the deformed projection onto the section in contact with the shaft is always maintained even without auxiliary means such as helical draw spring rings, for example.

The sealing disc may be made of polyphenylenesulfide (PPS) or polyamide (PA) for example. Both materials are advantageously low-priced, and the thread-shaped swirl groove is easily moldable.

Moreover, the sealing disc may be made of perfluorethylenepropylene. In contrast to polytetrafluorethylene, a sealing disc made of perfluorethylenepropylene has the advantage that this material is processable using the injection method.

Moreover, there is the possibility that the sealing disc is made of perfluoralcoxycopolymer. This material has the advantage that it is processable using the injection molding method.

The sealing disc may be made of a thermoplastic elastomer. The advantage here is that the connection to the supporting ring is possible without a complex pretreatment.

### BRIEF DESCRIPTION OF THE DRAWINGS

An exemplary embodiment of the sealing ring according to the present invention is explained in greater detail in the following, based upon the drawings, in which:

FIG. 1 shows the sealing ring in its original, uninstalled state;

FIG. 2 shows the sealing ring in FIG. 1 during its intended usage, installed in its installation space; and

FIG. 3 shows a cutout from the sealing disc in FIGS. 1 and 2 in an enlarged illustration.

### DETAILED DESCRIPTION

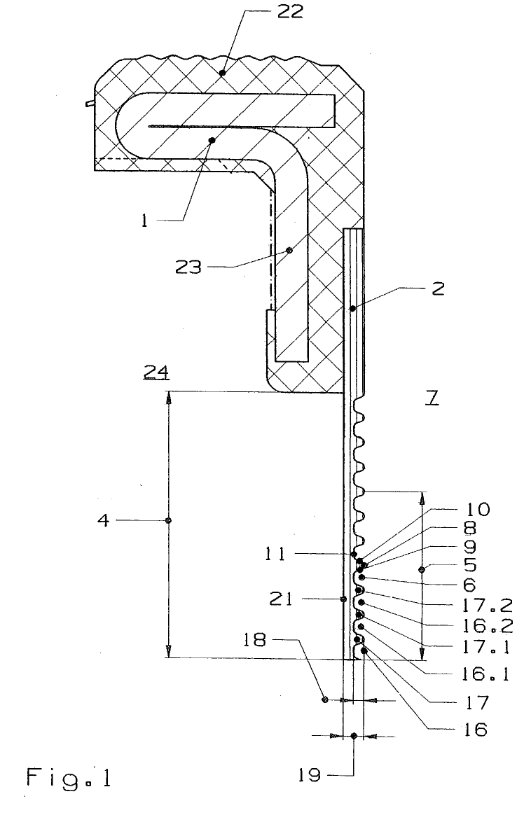

FIGS. 1 through 3 show an exemplary embodiment of a sealing ring having a supporting ring 1, sealing disc 2 being fixedly attached to supporting ring 1. Sealing disc 2 has a projection 4 that is conically deformed in the axial direction; projection 4 sealingly encloses shaft 3 to be sealed under prestress in section 5. Sealing disc 2 has a helical groove 6 on the side-facing shaft 3; groove 6 creates a return flow swirl and returns the medium to be sealed toward space 7 to be sealed during the rotation of the shaft. The advantageous usage properties of the sealing ring according to the present invention are the result of the trapezoidal profile of groove 6, and the fact that groove 6 has a cross section which is larger than the cross section of each web 17, 17.1, 17.2, . . . which separates the successive turns 16, 16.1, 16.2, . . . from one another. The trapezoidal profile of groove 6 and/or the cross section of groove 6 which is larger than the cross section of each web 17, 17.1, 17.2, . . . result in a large flow cross section and thus in a high return flow capability of the medium to be sealed toward the space to be sealed. Moreover, when carbonized oil is formed, the danger of clogging of the groove which would affect the function of the sealing ring is reduced. The best effect is achieved when the sealing ring has a groove 6 which has a trapezoidal profile and groove 6 has a cross section which is larger than the cross section of each web 17, 17.1, 17.2 . . . The good usage properties of the sealing ring at high operating temperatures in the range of approximately 160° C. and at high rotational speeds in the range of approximately 6000⁻¹ remain the same to the greatest possible extent at highly reduced carbonized oil formation; the medium to be sealed being mixed oils, for example.

FIG. 1 shows the sealing ring in its state as manufactured. Supporting ring 1 is completely enclosed by polymer material 22 and radially forms a static seal on the outside to a housing that is not illustrated here. Supporting ring 1 has an essentially T-shaped design, radial projection 23 of supporting ring 1 being connected to sealing disc 2 via polymer material 22.

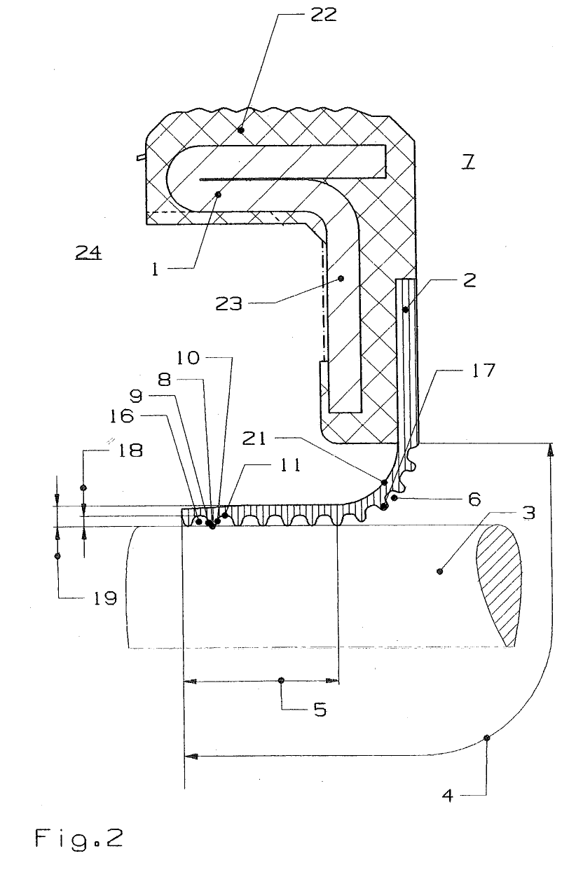

FIG. 2 shows the sealing ring of FIG. 1 in its installed state. With its projection 4 conically deformed in the axial direction, sealing disc 2 is in contact with the surface of shaft 3 to be sealed and is, in this exemplary embodiment, concave away from space 7 to be sealed, i.e., in the direction of surroundings 24.

In contrast, there is the possibility that sealing disc 2 is concave in the direction of space 7 to be sealed; also in such a case groove 6 is situated on the side of sealing disc 2 facing shaft 3 to be sealed.

Helical groove 6 is designed such that the medium to be sealed returns toward space 7 to be sealed.

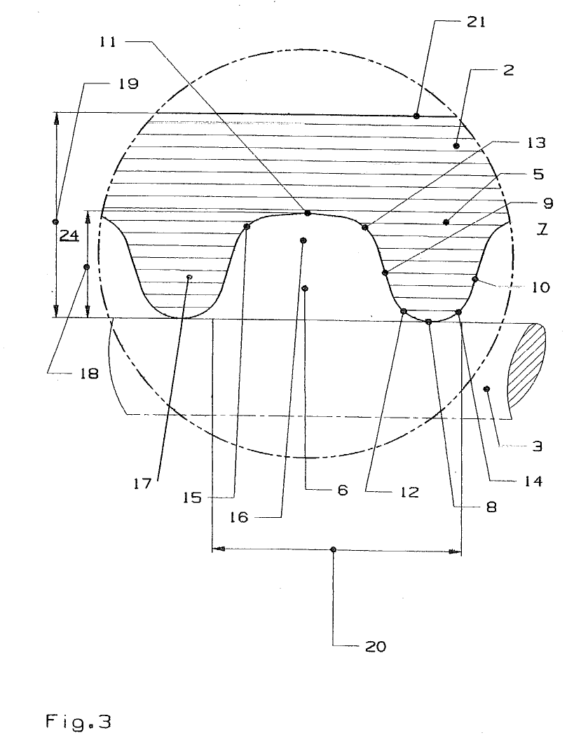

FIG. 3 shows an enlarged detail of sealing disc 2, groove 6 having a trapezoidal profile and a cross section which is larger than the cross section of each web 17, 17.1, 17.2, . . . separating successive turns 16, 16.1, 16.2, . . . from one another.

Sealing disc 2 has a cylindrical contact surface 8 to shaft 3, contact surface 8 being delimited in the axial direction on both sides by flank surfaces 9, 10 of groove 6 which are conically inclined toward one another.

Roundings 12, 13, 14, and 15 simplify the tool manufacture and achieve a more favorable hydraulic cross section; dead spaces in the corners of groove 6, in which carbonized oil could accumulate due to insufficient flow speed, are prevented.

The ratio of the cross section of groove 6 to the cross section of a web 17 is 1.5 in this exemplary embodiment, the profile of groove 6 being isosceles.

The groove has a depth of 0.26 mm. This is equal to 40% of thickness 19 of sealing disc 2. The pitch of successive turns 16, 16.1, 16.2, . . . of groove 6 measures 0.6 mm; the diameter of shaft 3 to be sealed measures 85 mm in this exemplary embodiment.

As a function of the respective circumstances of the application, groove 6 may form a component of a single-flight thread or a multi-flight thread. Single-flight threads are more cost-efficient to manufacture and are preferably used in engine seals to seal splash oil at slightly pulsating partial vacuum in the engine.

Multi-flight threads as groove 6 are to be preferred when an oil level at the sealing point has to be sealed at a slight overpressure in the space 7 to be sealed.

The sealing disc illustrated is particularly form-fitting with shaft 3 to be sealed and reliably seals shaft 3, also in the presence of deviations in form, position, and concentricity.

What is claimed is:

1. A sealing ring for sealing a shaft relative to an interior space, the sealing ring comprising:
a supporting ring; and
a sealing disc attached to the supporting ring, the sealing disc including a projection conically deformed in an axial direction of the shaft and having a first section in contact with the shaft, the first section including a helical groove having a trapezoidal cross section and configured to allow return of a medium toward the interior space.

2. The sealing ring as recited in claim 1, wherein the helical groove includes first and second flank surfaces adjacent a cylindrical bottom surface, the first section including a cylindrical contact surface delimited in the axial direction by the first and second flank surfaces inclined toward one another from adjacent turns of the helical groove.

3. The sealing ring as recited in claim 2, wherein the first section includes first roundings disposed between the contact surface and the flank surfaces and second roundings between the flank surfaces and the bottom surface.

4. The sealing ring as recited in claim 3, wherein each of the first and second roundings have a same radius.

5. The sealing ring as recited in claim 4, wherein the radius is between 0.05 mm and 0.2 mm.

6. A sealing ring for sealing a shaft relative to an interior space, the sealing ring comprising:
a supporting ring; and
a sealing disc attached to the supporting ring, the sealing disc including a projection conically deformed in an axial direction of the shaft and having a first section in contact with the shaft, the first section including a helical groove configured to allow return of a medium toward the interior space and a web separating adjacent turns of the helical groove, a cross section of the helical groove being larger than a cross section of the web.

7. The sealing ring as recited in claim 6, wherein a ratio of the cross section of the groove to the cross section of the web is at least 1.5.

8. The sealing ring as recited in claim 6 wherein the cross section of the groove has an isosceles shape.

9. The sealing ring as recited in claim 6 wherein the cross section of the groove has an scalene shape.

10. The sealing ring as recited in claim 6 wherein the groove forms at least part of a single-flight thread.

11. The sealing ring as recited in claim 6 wherein the groove forms at least part of a multi-flight thread.

12. The sealing ring as recited in claim 6 wherein the first section has a thickness and the groove has a depth, the depth being from 15% to 75% of the thickness.

13. The sealing ring as recited in claim 12 wherein the depth is from 35% to 45% of the thickness.

14. The sealing ring as recited in claim 6 wherein the groove has a depth between 0.2 mm and 0.4 mm.

15. The sealing ring as recited in claim 14 wherein the depth is between 0.25 mm to 0.28 mm.

16. The sealing ring as recited in claim 6 wherein adjacent turns of the groove have a pitch between 0.4 mm and 0.8 mm.

17. The sealing ring as recited in claim 16 wherein the pitch is between 0.5 mm to 0.7 mm.

18. The sealing ring as recited in claim 6, wherein the first section has an essentially flat surface on a side facing away from the groove.

19. The sealing ring as recited in claim 6, wherein the first section has an essentially wave-shaped surface on a side facing way from the groove.

20. The sealing ring as recited in claim 6, wherein the sealing disc includes a PTFE compound.

21. The sealing ring as recited in claim 6, wherein the sealing disc includes at least one of a PPS and a polyamide.

22. The sealing ring as recited in claim 6, wherein the sealing disc includes a perfluorethylenepropylene.

23. The sealing ring as recited in one claim 6, wherein the sealing disc includes a perfluoralcoxy copolymer.

24. The sealing ring as recited in claim 6, wherein the sealing disc includes an elastomer material.

25. The sealing ring as recited in claim 6, wherein the sealing disc includes a thermoplastic elastomer.

26. The sealing ring as recited in claim 6, wherein the sealing disc includes a cross-linked thermoplastic.
